(19) United States
(12) Patent Application Publication
(10) Pub. No.: US 2018/0283640 A1
(43) Pub. Date: Oct. 4, 2018

(54) Scanning Headlight for a Motor Vehicle

(71) Applicant: Volkswagen Aktiengesellschaft, Wolfsburg (DE)

(72) Inventor: Stefan Miemietz, Falkensee (DE)

(73) Assignee: Volkswagen Aktiengesellschaft, Wolfsburg (DE)

(21) Appl. No.: 15/944,821

(22) Filed: Apr. 4, 2018

(30) Foreign Application Priority Data
Apr. 4, 2017 (DE) 10 2017 205 723.8

(51) Int. Cl. F21S 41/63; B60Q 1/04; F21S 41/16

(52) U.S. Cl. CPC F21S 41/635; F21S 41/16; B60Q 1/04

(57) ABSTRACT

A scanning headlight for a motor vehicle comprises a light source and a projection optics, wherein the light source generates a light beam along the optical axis of the headlight. Furthermore, the headlight comprises a movable optical element, which is arranged between the light source and the projection optics, wherein a movement of the movable optical element with respect to the optical axis generates a deflection of the light beam from the optical axis.

### CROSS-REFERENCE TO RELATED APPLICATIONS

This application claims priority to DE Application No. 10 2017 205 723.8 filed Apr. 4, 2017 with the German Patent and Trademark Office, the contents of which application are hereby incorporated by reference in their entireties.

### TECHNICAL FIELD

The invention relates to a scanning headlight for a motor vehicle.

### BACKGROUND

Technologies are currently being sought with which a high-resolution front headlight for a pixel beam can be realized efficiently, cost-effectively and suitably for a motor vehicle. A method being considered for this is to not permanently illuminate the surface, as takes place with a classic headlight, but rather to direct one or more beams of light very quickly over the surface to be illuminated so that the movement cannot be detected by the human eye and to adjust the intensity of the light source during the movement so that the desired intensity distribution takes place over the surface to be illuminated. Such a headlight is also described as a scanning headlight.

Scanning headlights based on moving micro-mirrors are known. For technological reasons, these mirrors must be very small since the necessary quick oscillations are otherwise not possible, wherein it is insignificant whether the oscillation takes place in a resonant or forced manner. However, small mirror surfaces do not have the ability to dissipate the heat inevitably occurring in the case of high laser output on a small surface since the reflection level of such mirrors is less than 100%.

Furthermore, rotating mirror prisms are known, as are used, for example, in point of sale systems. In the case of this technology, the reflective surfaces are large enough that the lost heat in the case of high laser output is manageable. However, larger, quickly rotating systems form a gyro, which is exposed to extreme forces in a system moving in all degrees of freedom, as represented by a motor vehicle, which leads to quick wear and tear on the rotating mechanical system.

Optical image stabilizers in photographic objective lenses are also known based on movably mounted plane-parallel glass plates. These counterbalance a lateral offset of the light beams passing by the objective lens through an electronically controlled tilting. A vibration-caused displacement of the image on the image sensor is thereby counteracted.

The publication AT 514 333 A4 relates to a headlight for a vehicle with several light sources and an optical system assigned to the light sources, in which a first lighting unit with at least one light source for creating a first, dynamically variable illuminated image, as well as a second laser lighting unit with at least one laser light source, at least one beam deflection unit and at least one light conversion unit are provided. The optical system is set up to merge the illuminated image of the first lighting unit and the illuminated image created in the light conversion unit of the second laser lighting unit into a total light distribution on a roadway.

The publication DE 10 2012 100 139 A1 relates to a light module, in particular for a headlight of a vehicle, with at least one laser beam source and at least one converter element, which can be irradiated by the laser beam source with a laser beam, whereby light with a light spectrum qualified for a vehicle lighting system can be radiated by the converter element into at least one beam-forming element. At least one support element is thereby provided, on which the converter element is received and wherein the converter element can be moved with the support element at least with respect to the beam-forming element.

The weak point of previous scanning headlights is the movable mirror. The amount of light necessary for a front headlight cannot be focused on a micro-mirror without thermally overloading mirrors available today. The use of several micro-mirrors makes the system larger, more susceptible to faults and more complex in terms of construction, and therefore expensive. Furthermore, the use of large, quickly oscillating mirrors is problematic due to the mechanical load in the motor vehicle.

### SUMMARY

An object thus exists to create a motor-vehicle-suitable scanning headlight.

The object is solved by a headlight with the characteristics of claim 1. Embodiments of the invention are the subject matter of the dependent claims.

The headlight for a motor vehicle according to the invention comprises a light source and projection optics, wherein the light source generates a light beam along the optical axis of the headlight. Furthermore, the headlight comprises a movable optical element, which is arranged between the light source and the projection optics, wherein a movement of the movable optical element with respect to the optical axis generates a deflection of the light beam from the optical axis. In this manner, it is possible to generate a variable light distribution, in which a controlled scanning of the light beam after the projection optics is possible through the movement of the optical element.

### BRIEF DESCRIPTION OF THE DRAWINGS

The invention is explained in the following using exemplary embodiments. The drawings show in

FIG. 1 a scanning headlight with a tippable plane-parallel plate as an optical element and

FIG. 2 a scanning headlight with a displaceable lens system as an optical element.

### DETAILED DESCRIPTION OF EMBODIMENTS

In one embodiment, the movement of the movable optical element effectuates a deflection of the light beam after the projection optics in a range of 20° to 30°. In particular, the movement of the movable optical element may generate in another embodiment a scanning of the light beam within a specified spatial angle. It thus can be provided that a specified surface in front of the headlight is illuminated by a 2D scan.

In another embodiment, the movement of the optical element takes place/is effectuated in a frequency range of 200 Hz to 400 Hz. In this manner, the surface to be illuminated may be scanned sufficiently quickly so that the human eye detects the surface illuminated by the scanning headlight as continuous illumination.

According to another embodiment, the movable optical element is mounted contact-free in variable magnetic fields, whereby the quick scanning with the necessary frequency can be easily provided and the mounting is wear-free.

In another embodiment, the movable optical element is formed by a plane-parallel plate. This solution results in a small mass, which can be moved quickly and easily.

In yet another embodiment, the movement of the plane-parallel plate consists of a tipping of the plane-parallel plate with respect to the optical axis about a tipping angle, a tipping of the plane-parallel plate is easy to realize from a technical point of view.

According to a further embodiment, the plane-parallel plate has a triangular shape, wherein the triangular plane-parallel plate is hung/mounted in the corners. One hanging point may be passive in an embodiment and the other two hanging points may actively actuatable in an additional or alternative embodiment. In this manner, a simple hanging can be realized and a 2D scanning, i.e., a scanning of a spatial angle, can be realized in a defined manner via the two active hanging points, wherein the position and tipping of the triangular plate in two angles may be controlled due to the one passive hanging point.

In another embodiment, the movable optical element is formed by a lens system. According to a further embodiment, the movement of the lens system consists of a translation perpendicular to the optical axis. A translatory movement of the lens system in two spatial directions also effectuates a 2D scanning of the light beam after the projection optics, wherein translatory movements may be easier to control than tipping movements.

According to a further embodiment, the light source is formed by a laser. Since the fast movements of the movable optical element are easier generated with small masses, only well focusable light sources come into question as light sources, such as for example laser light sources.

Additional advantages, features and details of the invention are discussed in the following, in which various further exemplary embodiments are described in detail with reference to the drawings.

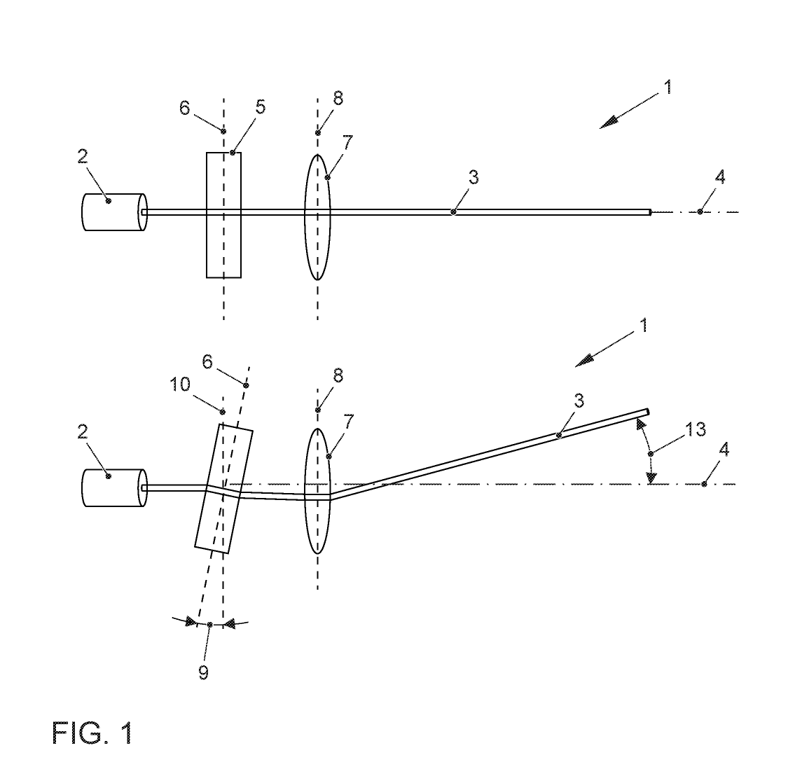

The basic mode of operation of a scanning headlight 1 according to an embodiment of the invention is explained based on FIG. 1, wherein the upper part of FIG. 1 is discussed in the following. The scanning headlight 1 thereby comprises a light source 2, such as a laser light source, which emits a light beam 3 along the optical axis 4 of the scanning headlight 1. The light beam 3 passes a first movable optical element, which is realized in this example by a plane-parallel plate 5 with symmetrical plane 6, wherein the symmetrical plane 6 is represented here as the axis of symmetry. In the upper part of FIG. 1, the plane-parallel plate 5 is arranged perpendicular to the optical axis 4, i.e., the symmetrical plane 6 of the plane-parallel plate 5 is perpendicular to the optical axis 4 of the scanning headlight. Consequently, the light beam 3 passes the plane-parallel plate 5 without deflection and moves along the optical axis 4 through a lens 7 arranged after the optical element 5 with symmetrical plane 8, which does not necessarily consist of a single lens, but can rather be realized by a lens system serving as the projection optics.

In the bottom part of FIG. 1, the plane-parallel plate 5 is tipped toward the optical axis 4 by an angle 9 with respect to the perpendicular 10. The tipping of the plane-parallel plate 5 by the angle 9 effectuates an offset of the light beam 3 by the optical element 5 from the optical axis 4 so that the light beam 3 falls outside of the center onto the lens 7 and is deflected upwards by a scan angle 13. The deflection of the light beam 3 from the optical axis 4 is a function of the tipping angle 9 of the optical element 5 designed as a plane-parallel plate so that a scanning of the light beam 3 takes place as a function of the tipping angle by means of a scanning of the tipping angle 9 after the lens 7, as it is shown by the scan angle 13. It should be apparent that a scanning of the light beam 3 by the optical element 5 in two spatial directions, i.e., 2D scanning over a spatial angle, enables an illumination of a surface by the scanning headlight 1.

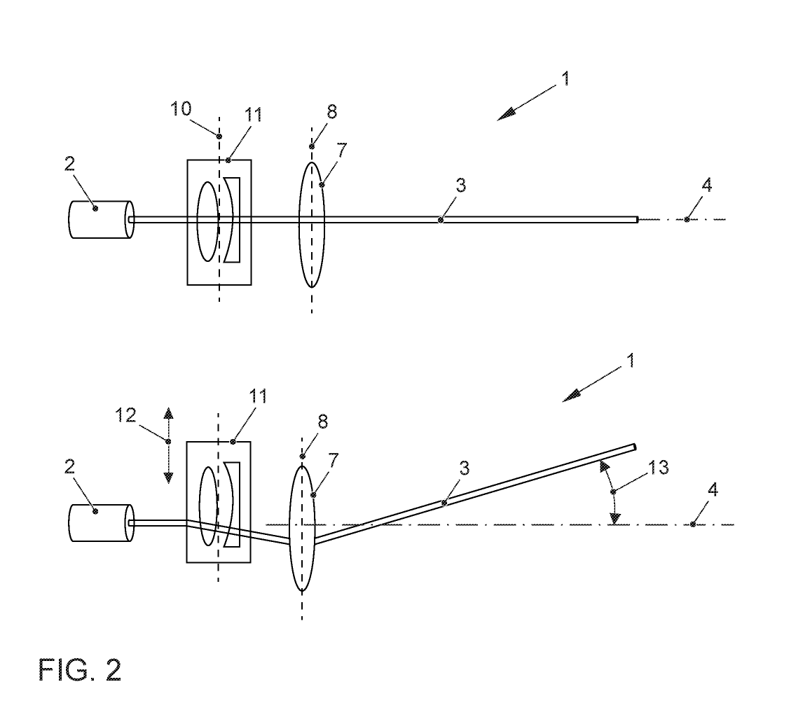

FIG. 2 shows a second embodiment of a scanning headlight 1, wherein only the differences from the embodiment according to FIG. 1 are discussed in the following. In this second embodiment, the movable optical element is formed by a lens system 11, which can be moved upwards and downwards in a translatory manner perpendicular to the optical axis 4 in the schematic representation in FIG. 2, as is shown symbolically by the movement arrow 12. In the upper part of FIG. 2, the lens system 11 is arranged symmetrically to the optical axis 4 so that a deflection of the light beam 3 does not occur in the lens system 11, and the light beam 3 thus extends along the optical axis of the scanning headlight 1.

In the bottom part of FIG. 2, the lens system 11 is deflected upwards. This translatory movement 12 leads to a deflection of the light beam 3 falling in along the optical axis 4 so that the light beam 3 falls outside of the optical axis 4 onto the lens 7 serving as the projection optics and is deflected upwards by a scan angle 13. As a function of the translatory movement 12, a scanning of the light beam 3 by specified scan angles 13 can thus be effectuated. Since the translation 12 can be executed in two spatial directions perpendicular to the optical axis 4, a 2D scanning of the light beam 3 can be achieved.

The deflection effectuated by the two movable optical elements discussed above, namely plane-parallel plate 5 or lens system 11, lies in the range of 20° to 30°. The tipping or respectively the translatory movement takes place at approx. 200 Hz to 400 Hz in order to provide an illumination of a surface without the human eye being able to detect the individual deflected light beams 3.

Depending on the requirements for the type and extent of the changeability of the light distribution, it can concern complex optical systems both in the case of the movable optical component, which is shown in FIG. 1 as movable, plane-parallel plate 5 and in FIG. 2 as lens system 11, as well as in the case of the subsequent projection optics 7, which is shown in FIGS. 1 and 2 as lens 7.

Since quick movements in a headlight can easily be generated with small masses, as in this example with thin, small glass plates or small lens systems, only well focusable light sources, generally lasers, are discussed as a light source.

The movable optical element 5, 11 can be mounted in different ways. A contact-free mounting in variable magnetic fields is optimal.

The movable optical element 5, 11 can have different shapes. This refers both to the shape of the inlet and outlet surfaces as well as to the position of the surfaces with respect to each other and the surface curvature. A plane-parallel plate 5 with a triangular shape with one passive and two active hanging points in the corners is optimal.

The parallelism ensures minimal aberrations since the beam geometry is mainly retained. The hanging with two active points and one passive point offers 2D deflection options with minimal constructive effort.

In the case of the use of several light sources and several optical elements 5, 11, the light sources in front of the optical elements 5, 11 can be combined into one beam and pass them together. In this embodiment, the dimensions of the optical elements 5, 11 remain minimal. Alternatively, the beams of several light sources can traverse the same optical elements 5, 11 at different points.

In this variant, the optical elements 5, 11 are larger and thus the effort of overlapping the beams in front of the optical elements 5, 11 is omitted.

An optical system for amplifying or converting the deflection of the beam 3 can be omitted if only minimal deflections are required on the imaging side, like when, for example, a phosphoric plate is illuminated in a structured manner for color conversion, which is subsequently projected in a magnified manner.

As already explained in the preceding, the movable optical element 5, 11 is not limited a plane-parallel plate 5, and a displacement of the original light beam 3 is also possible for example with a lens system 11 in which the movable optical element is not tilted but rather displaced in a translatory manner. In the case of this embodiment, a mechanically displaced optical system also effectuates an angle change of the beam path in the case of a fixed light source 2.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit may fulfil the functions of several items recited in the claims.

The mere fact that certain measures are recited in mutually different dependent claims or embodiments does not indicate that a combination of these measured cannot be used to advantage. Any reference signs in the claims should not be construed as limiting the scope.

### REFERENCE LIST

1 Scanning headlight
2 Light source
3 Light beam
4 Optical axis
5 Plane-parallel plate
6 Axis of symmetry
7 Lens
8 Axis of symmetry
9 Deflection angle
10 Perpendiculars to the optical axis
11 Lens system
12 Translatory movement
13 Scan angle

What is claimed is:

1. A headlight for a motor vehicle with a light source and projection optics, wherein the light source generates a light beam along the optical axis of the headlight, wherein a movable optical element is arranged between the light source and the projection optics, so that a movement of the movable optical element with respect to the optical axis generates a deflection of the light beam from the optical axis.

2. The headlight according to claim 1, wherein a deflection of the light beam in a range of 20° to 30° is effectuated by the movement of the movable optical element.

3. The headlight according to claim 1, wherein the movement of the movable optical element generates a scanning of the light beam within a specified spatial angle.

4. The headlight according to claim 1, wherein the movement of the optical element takes place in a frequency range of 200 Hz to 400 Hz.

5. The headlight according to claim 1, wherein the movable optical element is mounted in a contact-free manner in variable magnetic fields.

6. The headlight according to claim 1, wherein the movable optical element is formed by a plane-parallel plate.

7. The headlight according to claim 6, wherein the movement of the plane-parallel plate consists of a tipping of the plane-parallel plate by a tipping angle.

8. The headlight according to claim 7, wherein the plane-parallel plate has a triangular shape, wherein the triangular plane-parallel plate is hung in the corners, wherein one hanging point is passive and the other two hanging points are actively actuatable.

9. The headlight according to claim 1, wherein the movable optical element is formed by a lens system.

10. The headlight according to claim 9, wherein the movement of the lens system consists of a translation perpendicular to the optical axis.

11. The headlight according to claim 1, wherein the light source is formed by a laser.
